(19) United States
(12) Patent Application Publication
(10) Pub. No.: US 2026/0278885 A1
(43) Pub. Date: Sep. 17, 2026

(54) METHOD, APPARATUS, DEVICE, MEDIUM AND PROGRAM PRODUCT FOR ADJUSTING INTERFACE

(71) Applicant: Beijing Zitiao Network Technology Co., Ltd., Beijing (CN)

(72) Inventors: Tao YU, Beijing (CN); Shuo SUN, Beijing (CN)

(21) Appl. No.: 19/569,558

(22) Filed: Mar. 17, 2026

(30) Foreign Application Priority Data
Mar. 17, 2025 (CN) 202510315367.0

(51) Int. Cl. G06T 11/60

(52) U.S. Cl. CPC G06T 11/60; G06T 2200/24

(57) ABSTRACT

Embodiments of the present disclosure relate to a method, an apparatus, a device, a medium, and a program product for adjusting an interface. The method includes determining a layout for an interface, the layout including a sub-view and a parent layout for the sub-view. The method further includes determining whether a layout of the sub-view is fixed in response to the parent layout obtaining a layout update request for the sub-view. The method further includes setting, by the parent layout, a local rendering operation for the sub-view to scheduled operations to be performed in a next refresh period in response to the layout of the sub-view being fixed. The method further includes refreshing the sub-view based on the local rendering operation in the next refresh period in response to detecting a vertical synchronization signal.

### CROSS-REFERENCE TO RELATED APPLICATION(S)

This application claims priority to Chinese Application No. 202510315367.0 filed on Mar. 17, 2025, the disclosure of which is incorporated herein by reference in its entirety.

### FIELD

Embodiments of the present disclosure generally relate to the field of interfaces, and in particular, to a method, an apparatus, a device, a medium, and a program product for adjusting an interface.

### BACKGROUND

At present, in a live streaming scenario, more and more live streaming content is discovered and used to show to a large number of audiences watching the live streaming, including content in terms of popularizing knowledge, entertaining the public, competitive competitions, etc. In addition, during a process of a streamer streaming live, the streamer usually interacts with other streamers or audiences, and the other streamers or audiences may participate in the interaction together by inputting words or gifts in a live streaming room. As the popularity of the live streaming room gets higher and higher, the number of people participating in the interaction in the live streaming room will also increase, and at this time, a refresh frequency of information related to the interaction in the live streaming room will also become more and more frequent.

With the rise of the live streaming industry, more and more people begin to pay attention to this field and join the live streaming industry, and a number of streamers in the current live streaming industry has shown a blowout growth.

### SUMMARY

Embodiments of the present disclosure provide a method, an apparatus, a device, a medium, and a program product for adjusting an interface.

According to a first aspect of the present disclosure, a method for adjusting an interface is provided. The method includes determining a layout for an interface, the layout including a sub-view and a parent layout for the sub-view; determining whether a layout of the sub-view is fixed in response to the parent layout obtaining a layout update request for the sub-view; setting, by the parent layout, a local rendering operation for the sub-view to scheduled operations to be performed in a next refresh period in response to the layout of the sub-view being fixed; and refreshing the sub-view based on the local rendering operation in the next refresh period in response to detecting a vertical synchronization signal.

In a second aspect of the present disclosure, an apparatus for adjusting an interface is provided. The apparatus includes a layout determination module configured to determine a layout for an interface, the layout including a sub-view and a parent layout for the sub-view; a module for determining whether a layout of the sub-view is fixed, configured to determine whether the layout of the sub-view is fixed in response to the parent layout obtaining a layout update request for the sub-view; a local rendering operation setting module configured to set, by the parent layout, a local rendering operation for the sub-view to scheduled operations to be performed in a next refresh period in response to the layout of the sub-view being fixed; and a sub-view refreshing module configured to refresh the sub-view based on the local rendering operation in the next refresh period in response to detecting a vertical synchronization signal.

In a third aspect of the present disclosure, an electronic device is provided. The device includes at least one processor; and a memory device for storing at least one program, the at least one program, when executed by the at least one processor, causes the at least one processor to implement the method of the first aspect.

In a fourth aspect of the present disclosure, a computer-readable storage medium is provided. The medium has a computer program stored thereon, which, when executed by a processor, implements the method of the first aspect.

In a fifth aspect of the present disclosure, a computer program product is provided. The computer program product includes a computer program, which, when executed by a processor, implements the method of the first aspect.

It would be appreciated that content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other objects, features and advantages of the present disclosure will become more apparent through a more detailed description of exemplary embodiments of the present disclosure in conjunction with the drawings, in which the same reference numerals generally refer to the same components in the exemplary embodiments of the present disclosure.

FIG. 1 illustrates a schematic diagram of an example environment in which a device and/or a method of some embodiments of the present disclosure may be implemented;

FIG. 2 illustrates a schematic diagram of an example method 200 for adjusting an interface according to some embodiments of the present disclosure;

FIG. 3 illustrates a schematic diagram of an example of a specific process of a sub-view for adjusting an interface according to some embodiments of the present disclosure;

FIG. 4 illustrates a schematic diagram of an example of adjustment logic for adjusting an interface according to some embodiments of the present disclosure;

FIG. 5 illustrates a schematic diagram of a comparative example for adjusting an interface according to some embodiments of the present disclosure;

FIG. 6 illustrates a schematic block diagram of an apparatus for adjusting an interface according to some embodiments of the present disclosure; and

FIG. 7 illustrates a schematic block diagram of an example device suitable for implementing a plurality of embodiments of the present disclosure.

Throughout the drawings, the same or corresponding reference numerals represent the same or corresponding parts.

### DETAILED DESCRIPTION OF EMBODIMENTS

It would be appreciated that data involved in the technical solution (including but not limited to the data itself, acquisition or use of the data) should comply with requirements of corresponding laws, regulations, and related provisions.

It would be appreciated that before using the technical solutions disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, when receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select "agree" or "disagree" to provide the personal information to the electronic device.

It would be appreciated that the above process of notifying and obtaining user authorization is only illustrative and does not limit the implementations of the present disclosure, and other methods that satisfy the relevant laws and regulations may also be applied in the implementations of the present disclosure.

The embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein; on the contrary, these embodiments are provided for a more thorough and complete understanding of the present disclosure. It would be appreciated that the drawings and embodiments of the present disclosure are only for illustrative purposes and are not intended to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "an embodiment" or "the embodiment" should be understood as "at least one embodiment". The terms "first", "second", etc. may refer to different or same objects. Other definitions, either explicit or implicit, may also be included below.

In a process of interface adjustment, for example, taking a live streaming scenario as an example, in general, in special optimization for live streaming basic performance in an application, user interface (User Interface, UI) performance is a performance bottleneck point of a live streaming room. In a live streaming service, services in some live streaming rooms with high popularity may trigger frequent UI layout updates (such as a public screen). At present, a UI layout refresh mechanism is top-down, for example, after a UI refresh notification is triggered from a root layout, the UI refresh notification is passed down step by step to a parent layout and then to a sub-view, and finally a UI layout of a certain sub-view is refreshed. During this period, the top-down refresh mechanism involves a relatively large number of intermediate layout trees, which will waste system resources to a great extent and further affect system performance, especially in a complex business scenario such as live streaming.

Therefore, in a related traditional solution, by default, logic of re-refreshing a layout of a sub-layout corresponding to a sub-view in a display image is roughly divided into the following steps: firstly, the sub-view sends a layout change request, and after receiving the layout change request for the sub-view, the parent layout corresponding to the sub-view on a layout tree sends a layout change request for the parent layout to an upper-level layout on the layout tree again, until the root layout; subsequently, after receiving the layout change request from a lower-level layout, the root layout sends the layout change request to a manager, such as a choreographer (Choreographer). The manager is mainly configured to control a drawing rhythm, and detect a vertical synchronization signal, and when the vertical synchronization signal comes, a registered interface class (such as Runnable or FrameCallback) will be called back. Subsequently, after detecting the vertical synchronization signal for the layout change request, the manager sends layout operations layer by layer. For example, a measurement operation, a layout operation, and a drawing operation in the layout operations are sent to the root layout respectively, and then the root layout sends the measurement operation, the layout operation, and the drawing operation in the layout operations to the parent layout in the layout tree respectively, and finally the measurement operation, the layout operation, and the drawing operation in the layout operations are sent to the sub-layout, so as to implement the layout change for the sub-layout. In such a traditional solution, the calculation of the layout operations in the layout change request needs to be recalculated for the root layout, the parent layout, and the sub-layout, which will lead to a waste of a large amount of computing resources, a decline in system performance, and a poor user experience.

At least to solve the above and other potential problems, embodiments of the present disclosure provide a method for adjusting an interface. In this method, a computing device may first determine a layout for an interface. Among them, the layout includes a sub-view and a parent layout for the sub-view. Then, after the parent layout obtains a layout update request for the sub-view, it is determined whether a layout of the sub-view is fixed. Subsequently, after it is confirmed that the layout of the sub-view is fixed, the parent layout sets a local rendering operation for the sub-view to scheduled operations to be performed in a next refresh period. Finally, after a vertical synchronization signal is detected, the sub-view is refreshed based on the local rendering operation. Through this method, in a business scenario of frequent refresh, it is possible to perform local rendering on a view in a fixed layout without frequently rendering all views and layouts in the business scenario, which greatly improves a rendering frame rate for the business scenario, reduces the overhead of computing resources, and improves the user experience.

With a sharp increase in the number of streamers, interactive play methods for a plurality of streamers have also been created at the right moment. Different from the traditional live streaming by a single streamer, now a plurality of streamers may match each other for live streaming and may interact with each other to a certain extent at the same time, which greatly improves the joy of audiences watching the live streaming, increases a frequency of interaction between the streamers and the audiences, brings more popularity to the live streaming room, and also brings more severe challenges in terms of multi-streamer live streaming.

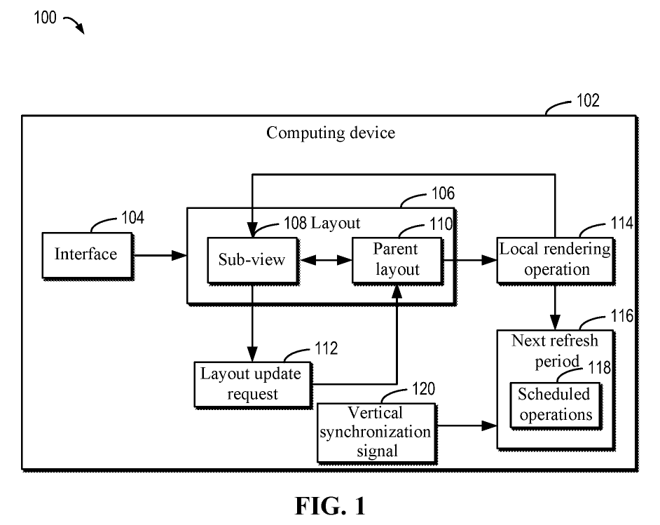

The embodiments of the present disclosure will be further described in detail below in conjunction with the drawings. FIG. 1 illustrates an example environment in which a device and/or a method of the embodiments of the present disclosure may be implemented. In environment 100, computing device 102 is used to process computing tasks required by a user when adjusting an interface, and it has interface 104, such as a user interface. Taking a live streaming scenario as an example, interface 104 may be an interface of a live streaming room corresponding to a streamer who is streaming live. Layout 106 of the interface may include a sub-view, a parent layout including the sub-view, and an upper-level layout. For example, the layout may include a plurality of live streaming components and a plurality of different views for the live streaming room. Among them, the sub-view 108 is controlled by the parent layout 110 to update the layout. After receiving a layout update request 112 from the sub-view, the parent layout first determines whether a layout of the sub-view 108 is fixed, and if it is fixed, sends a local rendering operation 114 for the sub-view to scheduled operations 118 in a next refresh period 116. Finally, after the system detects a vertical synchronization signal 120, the sub-view 108 is refreshed based on the local rendering operation 114.

Examples of the computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

It would be appreciated that the present application is only explained in combination with related embodiments, and the protection scope of the present application is not limited by the related embodiments, and any technical solution in other applications falling within the protection scope of the present application should be protected.

In the environment 100 of FIG. 1, the computing device 102 first determines the layout 106 for the interface 104. Among them, the layout 106 includes the sub-view 108 and the parent layout 110 for the sub-view 108. FIG. 1 shows that the layout for the interface includes a sub-view 108 and a parent layout, which is only an example, rather than a specific limitation to the present disclosure. The layout 106 may include any number of sub-views and parent layouts and any number of intermediate layouts under a root layout.

For example, for the layout 106 of the interface 104, there is a layout tree corresponding to the layout 106. The sub-view is a leaf node in the layout tree, and the parent layout 110 is an upper-level layout corresponding to the sub-view 108. The layout tree also has a top-level root layout, and in addition, there are many intermediate layout nodes.

The position of the sub-view 108 in the parent layout 110 may be obtained by the computing device 102, for example, an upper boundary, a lower boundary, a left boundary, and a right boundary of the sub-view 108 in the parent layout 110 are obtained. Additionally, the position of the sub-view 108 in the parent layout 110 may also be determined by obtaining coordinates of a center point of the sub-view 108 in the interface 104. For example, the sub-view may be used to display a received text message of a user.

Next, after obtaining the layout update request 112 for the sub-view 108, the parent layout 110 determines whether the layout of the sub-view 108 is fixed. In some embodiments, whether the layout of the sub-view 108 is fixed may be determined by obtaining a view identification for the sub-view 108. For example, after the view identification of the sub-view 108 is obtained, the view identification is compared with a stored set of view identifications for a set of sub-views with fixed layouts. If the same view identification exists in the set of view identifications, it is determined that the layout of the sub-view 108 is fixed, otherwise, it may be determined that the layout of the sub-view 108 is not fixed.

Additionally, the view identification of the sub-view 108 may be determined based on position information of the sub-view 108 in the parent layout, for example, based on boundary information or coordinate information of the sub-view 108 in the parent layout.

Subsequently, after it is confirmed that the layout of the sub-view 108 is fixed, the parent layout 110 sets the local rendering operation 114 for the sub-view 108 to the scheduled operations 118 to be performed in the next refresh period 116.

It should be noted that the computing device 102 starts a screen refresh operation after obtaining a vertical synchronization signal, thereby starting a new refresh period, for example, usually 60 vertical synchronization signals may be transmitted in 1 second, that is, there are 60 refresh periods.

In some embodiments, the scheduled operations 118 are directly started to be performed when the next refresh period arrives. Additionally, the scheduled operations 118 are animation operation processes in the next refresh period, which are located before a traditional refresh operation.

Finally, after detecting the vertical synchronization signal 120, the computing device 102 uses the local rendering operation 114 to refresh the sub-view 108. After the vertical synchronization signal 120 is detected, the interface 104 enters the next refresh period, and the computing device 102 uses the previously determined local rendering operation 114 to perform a rendering operation on the layout of the sub-view 108, so that the sub-view 108 is updated. Subsequently, the refreshed sub-view 108 is displayed on the interface.

Through this method, in a business scenario of frequent refresh, it is possible to perform customized local rendering on a view in a fixed layout without frequently rendering all views and layouts in the business scenario, which greatly improves a rendering frame rate for the business scenario, reduces the overhead of computing resources, and improves the user experience.

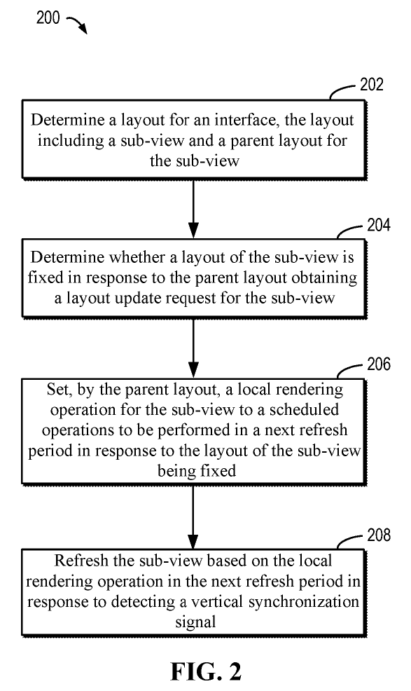

The schematic diagram of the example environment in which the device and/or the method of some embodiments of the present disclosure may be implemented is described above with reference to FIG. 1, and the schematic diagram of an example method 200 for interface adjustment according to some embodiments of the present disclosure is described below with reference to FIG. 2.

As shown in FIG. 2, in the example method 200, at a block 202, determines a layout for an interface is determined by the computing device 102, the layout including a sub-view and a parent layout for the sub-view. For example, layout 106 in FIG. 1 includes sub-view 108 and parent layout 110 for the sub-view 108.

It would be appreciated that due to the complexity of the live streaming scenario, the layout of the live streaming room is usually quite complicated. The layout of the live streaming room may usually be composed of a root layout, multi-level layouts under the root layout, and a sub-view.

In some embodiments, due to the complexity of the layout of the live streaming room, a relationship between the root layout and other respective layouts may usually be represented by a layout tree. In an example, there is usually only one root layout, while there may be a plurality of lower-level layouts corresponding to the root layout, and a specific number may be determined as needed.

In some embodiments, after obtaining the layout 106 for the interface, the computing device 102 further determines the parent layout 110 and the sub-view 108 for the interface 104 based on the root layout. Among them, the parent layout 110 is in one-to-one correspondence with the sub-view 108. In some embodiments, after the layout corresponding to the root layout is determined, a size, a position, etc. of a subsequent layout are determined layer by layer. Therefore, after the parent layout 110 is determined, position information of the sub-view 108 corresponding to the parent layout 110 in the interface 104 is also determined. Additionally, in addition to determining the position information of the sub-view 108, identification information for the sub-view is also determined. Additionally, the determination of the position information of the sub-view 108 is implemented within a refresh period.

It should be noted that there may be a plurality of refresh periods within a unit time (such as 1 second), for example, a refresh frame rate of a system screen is generally 60 frames per second, in which case one refresh period corresponds to 1/60 second, that is, about 16.6 milliseconds.

In addition, the update for the refresh period is implemented by receiving a vertical synchronization signal from the computing device 102. For example, each time a vertical synchronization signal from the device is received, the current refresh period is updated to the next refresh period.

After the position information of the sub-view 108 and the identification information of the sub-view 108 are determined, the position information of the sub-view 108 and the identification information of the sub-view 108 are stored in association.

Next, at a block 204, whether the layout of the sub-view is fixed is determined by the computing device 102, in response to the parent layout obtaining a layout update request for the sub-view.

After obtaining the layout update request 112 for the sub-view 108, the parent layout 110 first obtains a target view identification for the sub-view 108, and then matches the target view identification with a set of view identifications corresponding to a set of views with fixed layouts. If the target view identification is in the set of view identifications, it may be determined that the layout of the sub-view 108 is fixed.

Additionally, view identifications for the sub-view are divided into two groups, where view identifications in one group of view identifications represent that the layout of the sub-view is fixed, and view identifications in another group of view identifications represent that the layout of the sub-view is not fixed. If the target view identification matches a view identification in another group of view identifications, the layout of the sub-view 108 will cause the layout of the parent layout 110 and the layout of the root layout to be updated together.

Then, at a block 206, the local rendering operation for the sub-view is set by the parent layout to scheduled operations to be performed in the next refresh period, in response to the layout of the sub-view being fixed. If the computing device 102 determines that the layout of the sub-view 108 is fixed, a rendering notification for the layout update request 112 is generated. Subsequently, after obtaining the rendering notification, since the local rendering operation 114 cannot be implemented in the current refresh period at this time, the local rendering operation 114 for the sub-view is set to the scheduled operations 118 to be performed in the next refresh period 116, for example, an animation function operation in the next period.

Additionally, in the case that the layout of the sub-view 108 is fixed, the scheduled operations 118 to be performed in the next refresh period 116 are first performed by the computing device 102, and a priority of the scheduled operations 118 is higher than any other operation tasks to be performed.

If the computing device 102 determines that the layout of the sub-view 108 is not fixed, a global rendering operation for the sub-view 108, the parent layout 110, and the root layout is performed in the next refresh period 116.

Among them, operation steps and content in the global rendering operation and the local rendering operation 114 are consistent, but in the global rendering operation, each operation step in the rendering operation needs to be performed once for the root layout, the parent layout 110, and the sub-view 108.

In some embodiments, the acquisition of the scheduled operations 118 are realized by calling a system-level scheduled method, such as a View.postOnAnimation method. The View.postOnAnimation method sets the measurement, the layout, and the drawing operation for the sub-view to the scheduled operations in the next period.

Finally, at a block 208, the sub-view is refreshed based on the local rendering operation in the next refresh period in response to detecting a vertical synchronization signal. After the vertical synchronization signal 120 for the next refresh period 116 is detected, the local rendering operation 114 may be sent to the parent layout 110, and the parent layout 110 may be used to perform the local rendering operation 114 for the sub-view 108.

Additionally, the local rendering operation 114 includes a measurement operation, a layout operation, and a drawing operation. Among them, the measurement operation is used to perform the measurement operation for the sub-view 108 to determine a size of the sub-view 108, the layout operation is used to perform the layout operation for the sub-view 108 to determine the position of the sub-view 108, and the drawing operation is used to perform the drawing operation for the sub-view 108 to present the sub-view 108 or the refreshed sub-view.

Additionally, operations in the scheduled operations 118 in the next refresh period 116 are the same as operations in the local rendering operation 114.

In an example, the layout operation for the position of the sub-view 108 may be used to determine a left boundary, a right boundary, an upper boundary, and a lower boundary of the sub-view 108 in the parent layout 110.

When the local rendering operation 114 for the sub-view 108 is performed, the refreshed sub-view 108 is displayed on the interface 104.

Through this method, in a business scenario of frequent refreshing, it is possible to perform customized local rendering on a view in a fixed layout without frequently rendering all views and layouts in the business scenario, which greatly improves a rendering frame rate for the business scenario, reduces the overhead of computing resources, and improves the user experience.

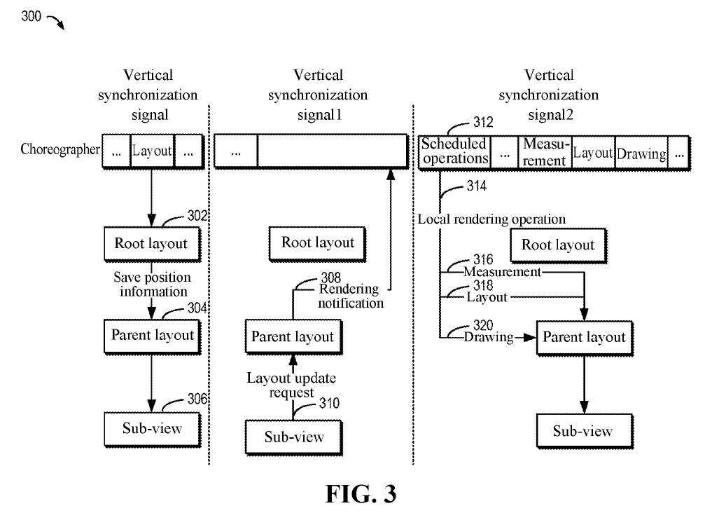

The schematic diagram of the example method for interface adjustment according to some embodiments of the present disclosure is described above with reference to FIG. 2, and the schematic diagram of an example of a specific process of a sub-view for interface adjustment according to some embodiments of the present disclosure is described below with reference to FIG. 3. This process may be performed by the computing device 102 in FIG. 1.

In this example, a refresh frequency of content in the sub-view may be much higher than a refresh frequency of content in the parent layout. For example, taking a live streaming scenario as an example, in the case that there are a large number of people in a live streaming room, the sub-view is used to display text bullet comments and gifts sent by audience who are watching the live streaming, so the sub-view needs to be refreshed constantly. Preferably, the sub-view may also be a view for displaying a text message of a user. It should be noted that the choreographer is mainly configured to control a drawing rhythm, detect a vertical synchronization signal, and call back a registered interface class function when the vertical synchronization signal comes.

In example 300, after the vertical synchronization signal is detected, the computing device 102 first obtains a root layout 302 within a refresh period corresponding to the vertical synchronization signal, and then position information in the root layout is saved based on the obtained root layout 302. Additionally, the position information includes position information of a parent layout 304.

Then, the computing device determines position information of a sub-view 306 based on the position information of the parent layout 304. Additionally, the computing device 102 further obtains a view identification of the sub-view 306. Whether the layout of the sub-view 306 is fixed may be preset.

The computing device detects a vertical synchronization signal 1 and thus enters a refresh period corresponding to the vertical synchronization signal 1. In the refresh period corresponding to the vertical synchronization signal 1, the parent layout receives a layout update request 310 from the sub-view, and then the parent layout determines whether the update request is from a sub-view with a fixed layout. If the update request is from the sub-view with the fixed layout, the parent layout then generates a rendering notification 308 for the layout update request 310.

After receiving the rendering notification 308 for the layout update request 310, the computing device puts a local rendering (e.g., measurement/layout/redraw) operation into earliest scheduled operations 312 (e.g., an animation method) of a vertical synchronization signal 2. If the vertical synchronization signal 2 is detected again, a refresh period corresponding to the vertical synchronization signal 2 is entered. Since the parent layout has set a local rendering operation 314 for the sub-view in the scheduled operations 312 in the refresh period corresponding to the vertical synchronization signal 1, in the refresh period corresponding to the vertical synchronization signal 2, the parent layout may use a measurement operation 316, a layout operation 318, and a drawing operation 320 in the local rendering operation to render and refresh the sub-view. Finally, the refreshed sub-view is displayed on the interface.

Through this method, repeated execution of measurement, layout, and drawing in the rendering operation in the root layout, the parent layout, and the sub-view is avoided, which greatly improves the utilization of system computing resources, improves the device performance in the live streaming scenario, and improves the user experience together.

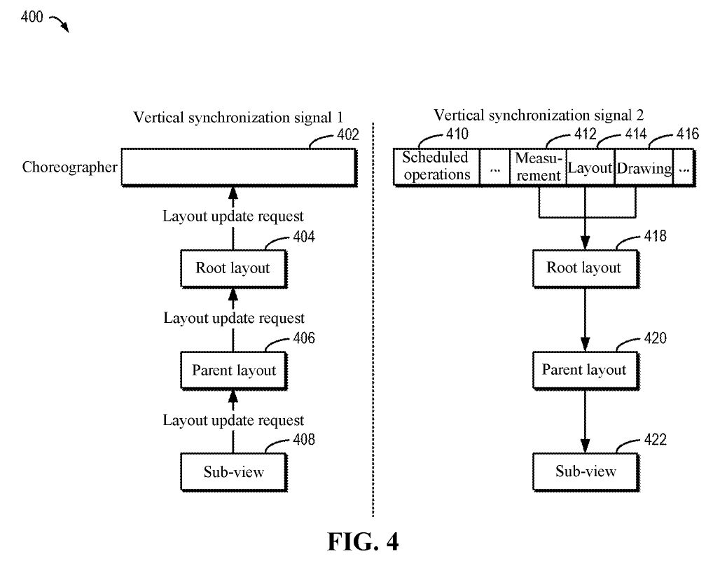

The schematic diagram of the example of the specific process of the sub-view for interface adjustment according to some embodiments of the present disclosure is described above with reference to FIG. 3, which is an operation in the case that the layout of the sub-view is fixed. The schematic diagram of an example of adjustment logic for interface adjustment according to some embodiments of the present disclosure is described below with reference to FIG. 4, in which the layout of the sub-view is not fixed. This process may be performed by the computing device 102 in FIG. 1.

Block 402 represents a refresh period corresponding to a vertical synchronization signal 1, in which a layout update request is first sent to a parent layout 406 by a sub-view 408. After receiving the layout request, the parent layout determines that the layout of the sub-view 408 is not fixed. In this case, after receiving the layout update request, the parent layout 406 sends an update request for the parent layout to a root layout 404.

Subsequently, after a vertical synchronization signal 2 is detected, the next refresh period is entered. In this case, since the computing device 102 determines that the layout of the sub-view 408 is not fixed, the computing device does not set a local rendering operation for the sub-view to scheduled operations 410 in the next refresh period, but directly uses a preset global rendering operation, such as measurement 412, layout 414, and drawing 416 operations, to perform a layout refresh operation on the root layout 418.

Subsequently, after the root layout 418 undergoes the global rendering operation, the measurement 412, the layout 414, and the drawing 416 are further used to perform the global rendering operation on the parent layout 420 to refresh the parent layout 420. Finally, after the parent layout 420 undergoes the global rendering operation, the measurement 412, the layout 414, and the drawing 416 are further used to perform a rendering operation on the sub-view 422 to refresh the sub-view 422.

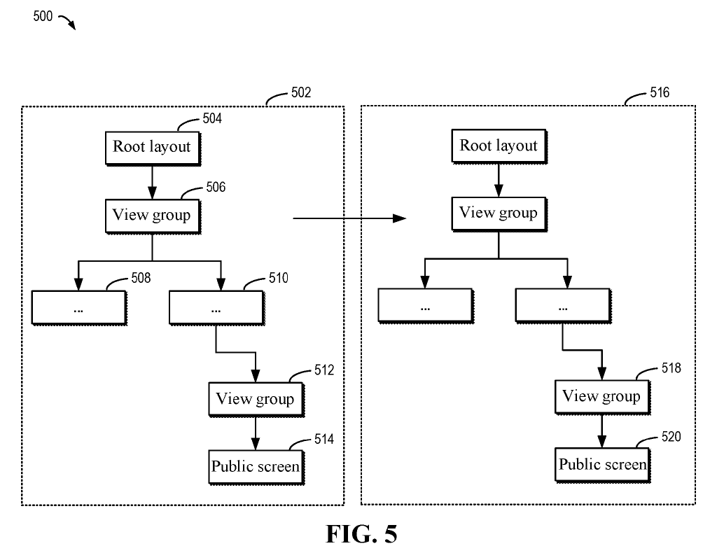

The schematic diagram of the example of the adjustment logic for interface adjustment according to some embodiments of the present disclosure is described above with reference to FIG. 4, and the schematic diagram of a comparative example for interface adjustment according to some embodiments of the present disclosure is described below with reference to FIG. 5. This process may be performed by the computing device 102 in FIG. 1.

As shown in FIG. 5, in example 500, in a pre-optimization process 502, it may be seen that under a view group 506 for a root layout 504, there are a view group 508 and a view group 510, and a view group 512 corresponding to a sub-view acting as a public screen 514.

After receiving a layout change request from the public screen 514, whether or not the public screen has a fixed layout, a preset global rendering operation measurement, layout, and drawing are directly used to perform a layout refresh operation on the root layout 504 after the vertical synchronization signal is detected and the next refresh period is switched to.

Subsequently, after the root layout 504 undergoes the global rendering operation, the measurement, the layout, and the drawing are further used to operate on the view groups 506, 510, 512 and the sub-view 514 to refresh the layout. Therefore, after the global rendering operation is performed, the refreshed public screen 514 is finally displayed on the interface.

In an optimized process 516, after receiving a layout update request from a public screen 518 acting as a sub-view, a view group 518 may be used to determine whether the public screen is a sub-view with a fixed layout. If the public screen 520 is a sub-view with a fixed layout, a local rendering operation is performed on the public screen 520 in the next refresh period to refresh the public screen 520. Then, the refreshed public screen is displayed on the interface.

Through this method, in the case that the layout of the sub-view is fixed, the computing resources consumed by rendering the root layout and the parent layout may be greatly saved, the device performance and the live streaming performance may be improved, and the user experience may be improved.

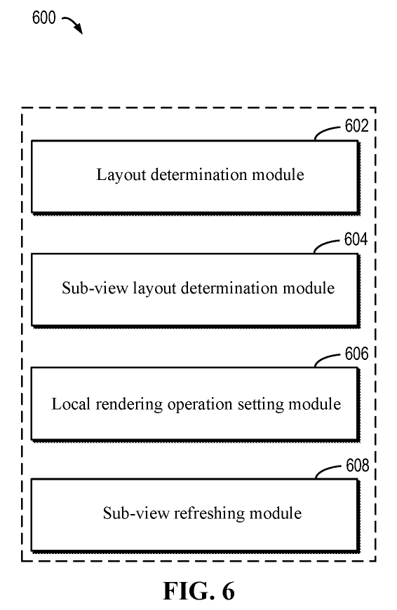

As shown in FIG. 6, the apparatus 600 includes a layout determination module 602 configured to determine a layout for an interface, the layout including a sub-view and a parent layout for the sub-view; a sub-view layout determination module 604 configured to determine whether a layout of the sub-view is fixed in response to the parent layout obtaining a layout update request for the sub-view; a local rendering operation setting module 606 configured to set, by the parent layout, a local rendering operation for the sub-view to scheduled operations to be performed in a next refresh period in response to the layout of the sub-view being fixed; and a sub-view refreshing module 608 configured to refresh the sub-view based on the local rendering operation in the next refresh period in response to detecting a vertical synchronization signal.

In some embodiments, the layout determination module 602 includes: a root layout obtaining module configured to obtain a root layout for the interface; and a parent layout and sub-view determination module configured to determine the parent layout and the sub-view for the interface based on the root layout.

In some embodiments, the layout determination module 602 further includes: a module for determining position information of the sub-view, configured to determine position information of the sub-view in the interface based on the parent layout; and a module for saving the position information and an identification of the sub-view, configured to save the position information and the identification of the sub-view in association.

In some embodiments, the sub-view layout determination module 604 includes: a target view identification obtaining module configured to obtain a target view identification for the sub-view in response to the parent layout obtaining the layout update request for the sub-view; and a fixed layout determination module configured to determine that the layout of the sub-view is fixed in response to the target view identification being in a set of view identifications, the set of view identifications corresponding to a set of sub-views with fixed layouts.

In some embodiments, the local rendering operation setting module 606 includes: a rendering notification generation module configured to generate a rendering notification for the layout update request in response to the layout of the sub-view being fixed; and a local rendering operation setting module configured to set, by the parent layout, the local rendering operation for the sub-view to the scheduled operations to be performed in the next refresh period based on the rendering notification.

In some embodiments, the sub-view refreshing module 608 includes: a local rendering operation sending module configured to send the local rendering operation to the parent layout in response to detecting the vertical synchronization signal; and a local rendering operation execution module configured to perform the local rendering operation for the sub-view using the parent layout.

In some embodiments, the local rendering operation execution module includes: a measurement operation execution module configured to perform a measurement operation for the sub-view to determine a size of the sub-view; a layout operation execution module configured to perform a layout operation for the sub-view to determine a position of the sub-view; and a drawing operation execution module configured to perform a drawing operation for the sub-view to present the sub-view.

In some embodiments, the position includes a left boundary, a right boundary, an upper boundary, and a lower boundary of the sub-view in the parent layout.

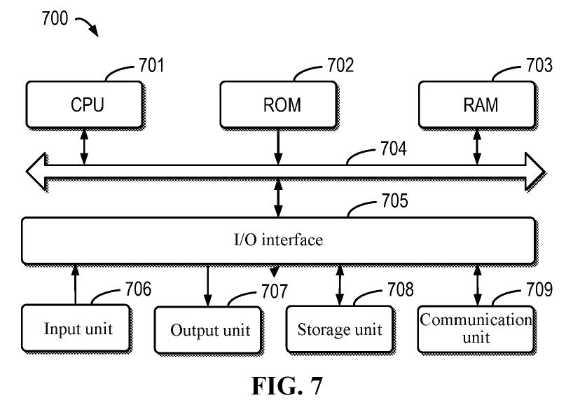

FIG. 7 shows a schematic block diagram of an example device 700 that may be used to implement the embodiments of the present disclosure. The computing device 102 in FIG. 1 may be implemented using the device 700. As shown in the figure, the device 700 includes a central processing unit (CPU) 701, which may perform various appropriate actions and processes based on computer program instructions stored in a read-only memory (ROM) 702 or computer program instructions loaded from a storage unit 708 into a random access memory (RAM) 703. In the RAM 703, various programs and data required for operations of the device 700 may also be stored. The CPU 701, the ROM 702, and the RAM 703 are connected to each other through a bus 704. An input/output (I/O) interface 705 is also connected to the bus 704.

A plurality of components in the device 700 are connected to the I/O interface 705, and the components include: an input unit 706, such as a keyboard, a mouse, etc.; an output unit 707, such as various types of displays, speakers, etc.; a storage unit 708, such as a magnetic disk, an optical disc, etc.; and a communication unit 709, such as a network card, a modem, a wireless communication transceiver, etc. The communication unit 709 allows the device 700 to exchange information/data with other devices through a computer network such as Internet and/or various telecommunication networks.

The respective processes and treatments described above, such as the method 200 and examples 300 to 500, may be executed by the processing unit 701. For example, in some embodiments, the method 200 and examples 300 to 500 may be implemented as a computer software program, which is tangibly contained in a machine-readable medium, such as the storage unit 708. In some embodiments, a portion or an entirety of the computer program may be loaded and/or installed into the device 700 via the ROM 702 and/or the communication unit 709. When the computer program is loaded into the RAM 703 and executed by the CPU 701, one or more actions of the example method 200 and examples 300 to 500 described above may be performed.

The present disclosure may be a method, an apparatus, a system, and/or a computer program product. The computer program product may include a computer-readable storage medium having computer-readable program instructions thereon for performing various aspects of the present disclosure.

The computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punched card or a raised structure in a groove with instructions stored thereon, and any suitable combination of the foregoing. The computer-readable storage medium used herein is not interpreted as an instantaneous signal per se, such as a radio wave or other freely propagating electromagnetic waves, electromagnetic waves propagating through a waveguide or other transmission media (e.g., light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a user's computer, partly executed on a user's computer, executed as an independent software package, partly executed on a user's computer and partly executed on a remote computer, or entirely executed on a remote computer or a server. In the case involving the remote computer, the remote computer may be connected to the user's computer through any kind of network, including a local area network (LAN) or a wide area network (WAN), or it may be connected to an external computer (for example, connected by using Internet provided by an Internet service provider). In some embodiments, by personalizing an electronic circuit, such as a programmable logic circuit, a field programmable gate array (FPGA) or a programmable logic array (PLA), using state information of the computer-readable program instructions, the electronic circuit may execute the computer-readable program instructions, thereby implementing various aspects of the present disclosure.

Various aspects of the present disclosure are described herein with reference to flowcharts and/or block diagrams of methods, apparatuses (systems), and computer program products according to embodiments of the present disclosure. It would be appreciated that each block of the flowcharts and/or block diagrams, and a combination of respective blocks in the flowcharts and/or block diagrams may be implemented by the computer-readable program instructions.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus that implements a function/action specified in one or more blocks of the flowcharts and/or block diagrams is produced. These computer-readable program instructions may also be stored in a computer-readable storage medium, and these instructions cause the computer, the programmable data processing apparatus, and/or other devices to work in a specific manner, so that the computer-readable medium having the instructions stored therein includes a manufactured product, which includes instructions for implementing various aspects of the function/action specified in one or more blocks of the flowcharts and/or block diagrams.

The computer-readable program instructions may also be loaded onto a computer, other programmable data processing apparatus, or other devices, so that a series of operations and steps are performed on the computer, other programmable data processing apparatus, or other devices to produce a computer-implemented process, so that the instructions executed on the computer, other programmable data processing apparatus, or other devices implement the function/action specified in one or more blocks of the flowcharts and/or block diagrams.

The flowcharts and block diagrams in the drawings show the possibly implemented architectures, functions, and operations of the system, the method, and the computer program product according to a plurality of embodiments of the present disclosure. In this regard, each block in the flowchart or block diagram may represent a module, a program segment, or a portion of an instruction, and the module, the program segment, or the portion of the instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that performs a specified function or action, or may be implemented by a combination of dedicated hardware and computer instructions.

The embodiments of the present disclosure have been described above, and the above description is exemplary, non-exhaustive, and not limited to the disclosed embodiments. Without departing from the scope and spirit of the described embodiments, many modifications and changes will be apparent to those of ordinary skill in the art. The terms used herein are chosen to best explain the principles of the embodiments, the actual application or the technical improvement to the technology in the market, or to enable other ordinary skilled persons in the art to understand the embodiments disclosed herein.

We claim:

1. A method for adjusting an interface, comprising:
determining a layout for the interface, the layout comprising a sub-view and a parent layout for the sub-view;
determining whether a layout of the sub-view is fixed in response to the parent layout obtaining a layout update request for the sub-view;
setting, by the parent layout, a local rendering operation for the sub-view to a scheduled operation to be performed in a next refresh period in response to the layout of the sub-view being fixed; and
refreshing the sub-view based on the local rendering operation in the next refresh period in response to detecting a vertical synchronization signal.

2. The method of claim 1, wherein determining the layout for the interface comprises:
obtaining a root layout for the interface; and
determining the parent layout and the sub-view for the interface based on the root layout.

3. The method of claim 2, further comprising:
determining position information of the sub-view in the interface based on the parent layout; and
saving the position information and an identification of the sub-view in association.

4. The method of claim 1, wherein determining whether the layout of the sub-view is fixed comprises:
obtaining a view identification for the sub-view in response to the parent layout obtaining the layout update request for the sub-view; and
determining that the layout of the sub-view is fixed in response to the view identification being in a set of view identifications, the set of view identifications corresponding to a set of sub-views with fixed layouts.

5. The method of claim 1, wherein setting, by the parent layout, the local rendering operation for the sub-view to the scheduled operation to be performed in the next refresh period comprises:
generating a rendering notification for the layout update request in response to the layout of the sub-view being fixed; and
setting, by the parent layout, the local rendering operation for the sub-view to the scheduled operation to be performed in the next refresh period based on the rendering notification.

6. The method of claim 1, wherein refreshing the sub-view based on the local rendering operation in the next refresh period comprises:
sending the local rendering operation to the parent layout in response to detecting the vertical synchronization signal; and
performing the local rendering operation for the sub-view using the parent layout.

7. The method of claim 6, further comprising:
displaying the refreshed sub-view on the interface in response to the local rendering operation being performed.

8. The method of claim 6, wherein performing the local rendering operation for the sub-view using the parent layout comprises:
performing a measurement operation for the sub-view to determine a size of the sub-view;
performing a layout operation for the sub-view to determine a position of the sub-view; and
performing a drawing operation for the sub-view to present the sub-view.

9. The method of claim 8, wherein the position comprises:
the sub-view being on a left boundary, a right boundary, an upper boundary, and a lower boundary of the parent layout.

10. The method of claim 1, wherein the interface is a live streaming interface, and the sub-view is a view for displaying a text message.

11. An electronic device, comprising:
at least one processor; and
a memory device for storing at least one program, the at least one program, when executed by the at least one processor, causes the at least one processor to:
determine a layout for the interface, the layout comprising a sub-view and a parent layout for the sub-view;
determine whether a layout of the sub-view is fixed in response to the parent layout obtaining a layout update request for the sub-view;
set, by the parent layout, a local rendering operation for the sub-view to a scheduled operation to be performed in a next refresh period in response to the layout of the sub-view being fixed; and
refresh the sub-view based on the local rendering operation in the next refresh period in response to detecting a vertical synchronization signal.

12. The electronic device of claim 11, wherein the at least one program causing the at least one processor to determine the layout for the interface comprises instructions to:
obtain a root layout for the interface; and
determine the parent layout and the sub-view for the interface based on the root layout.

13. The electronic device of claim 12, wherein the at least one program further comprises instructions to:
determine position information of the sub-view in the interface based on the parent layout; and
save the position information and an identification of the sub-view in association.

14. The electronic device of claim 11, wherein the at least one program causing the at least one processor to determine whether the layout of the sub-view is fixed comprises instructions to:
obtain a view identification for the sub-view in response to the parent layout obtaining the layout update request for the sub-view; and
determine that the layout of the sub-view is fixed in response to the view identification being in a set of view identifications, the set of view identifications corresponding to a set of sub-views with fixed layouts.

15. The electronic device of claim 11, wherein the at least one program causing the at least one processor to set, by the parent layout, the local rendering operation for the sub-view to the scheduled operation to be performed in the next refresh period comprises instructions to:
generate a rendering notification for the layout update request in response to the layout of the sub-view being fixed; and
set, by the parent layout, the local rendering operation for the sub-view to the scheduled operation to be performed in the next refresh period based on the rendering notification.

16. The electronic device of claim 11, wherein the at least one program causing the at least one processor to refresh the sub-view based on the local rendering operation in the next refresh period comprises instructions to:
send the local rendering operation to the parent layout in response to detecting the vertical synchronization signal; and
perform the local rendering operation for the sub-view using the parent layout.

17. The electronic device of claim 16, wherein the at least one program further comprises instructions to:
display the refreshed sub-view on the interface in response to the local rendering operation being performed.

18. The electronic device of claim 16, wherein the at least one program causing the at least one processor to perform the local rendering operation for the sub-view using the parent layout comprises instructions to:
perform a measurement operation for the sub-view to determine a size of the sub-view;
perform a layout operation for the sub-view to determine a position of the sub-view; and
perform a drawing operation for the sub-view to present the sub-view.

19. The electronic device of claim 18, wherein the position comprises:
the sub-view being on a left boundary, a right boundary, an upper boundary, and a lower boundary of the parent layout.

20. A non-transitory computer-readable storage medium having a computer program stored thereon, wherein the computer program, when executed by a processor, causes the processor to:
determine a layout for the interface, the layout comprising a sub-view and a parent layout for the sub-view;
determine whether a layout of the sub-view is fixed in response to the parent layout obtaining a layout update request for the sub-view;
set, by the parent layout, a local rendering operation for the sub-view to a scheduled operation to be performed in a next refresh period in response to the layout of the sub-view being fixed; and
refresh the sub-view based on the local rendering operation in the next refresh period in response to detecting a vertical synchronization signal.
